(19) United States
(12) Patent Application Publication
(10) Pub. No.: US 2012/0089345 A1
(43) Pub. Date: Apr. 12, 2012

(54) METHOD FOR MEASURING THE COMPRESSIBILITY AND RESONANT FREQUENCY OF DISC BRAKE PADS

(75) Inventors: Andreas Giese, Glinde (DE); Christoph Kölsch, Glinde (DE)

(73) Assignee: HONEYWELL BREMSBELAG GMBH, Glinde (DE)

(21) Appl. No.: 13/253,258

(22) Filed: Oct. 5, 2011

(30) Foreign Application Priority Data
Oct. 7, 2010 (DE) 102010042169.3

(51) Int. Cl. G06F 19/00; G01L 5/28

(52) U.S. Cl. 702/33; 73/121

(57) ABSTRACT

A method for separately measuring the compressibility and resonant frequency of a disc brake pad allows better conclusions to be drawn as to the properties of the disc brake pads by creating identical test conditions for measuring the compressibility and resonant frequency for the purpose of quality assurance. The method includes performing the compressibility and resonant frequency measurements on the same disc brake pad in a time-delayed manner, immediately one after the other.

The invention relates to a method for separately measuring the compressibility and resonant frequency of disc brake pads.

In addition the invention relates to an apparatus for carrying out the method.

Methods of the kind mentioned above are commonly known and familiar to an expert in the art.

A particularly capable instrument for measuring compressibility, i.e. the change in the thickness of the brake pad under a one-dimensional compressive load which acts along the centre line perpendicular to the frictional surface of the pad, has proven to be the compressibility-measuring instrument by Messrs. Honeywell. It was found that compressibility is an important measured variable in the area of quality control, since it is dependent, in particular, also on brake pad elasticity.

Resonant frequencies of disc brake pads as a result of vibrational stimulation represent a further important factor for checking the material properties of disc brake pads with a view to assuring quality. Here again the elasticity of the brake pad represents an important influence on the resonant frequency.

In order to record the vibrations, contactless microphone measuring has been developed in the recent past. Contactless microphone measuring means that a microphone records the vibrations of the stimulated disc brake pad. The measured data is analysed by means of suitable resonant frequency analysis software and the resonant frequency is then ascertained mathematically.

In the field of quality assurance the standard procedure continues to be measuring the compressibility of samples of disc brake pads. Occasionally the resonant frequency of disc brake pads is additionally measured and used as a quality criterium. However, this is not carried out on the same sample, which again is disadvantageous in that the test conditions are different, which means that the measured values ascertained on the basis of different measuring methods do not always permit reliable conclusions to be drawn as to the properties of the disc brake pads.

It is therefore the requirement of the invention to further develop a method of the kind mentioned in the beginning, which, by creating identical test conditions, allows better conclusions to be drawn as regards the properties of disc brake pads via measuring the compressibility and resonant frequency for the purpose of quality assurance.

This requirement is met by the features of claim 1. Advantageous implementations can be derived from the sub-claims.

The invention provides for measuring the compressibility and resonant frequency on the same disc brake pad in a time-delayed manner, immediately one after the other.

The core idea of the invention consists in that the resonant frequency is also measured in a standard manner, i.e. by using the same disc brake pad sample for measuring both compressibility and resonant frequency. Thus in an inventive way the two measurements (compressibility measurement and resonant frequency measurement) are dovetailed both as regards time and space.

It is an advantage of the invention that the two disc brake pad factors, i.e. resonant frequency and compressibility, which are important to development and quality control, can be determined in a robust and simple way using a combined measuring procedure involving a time delay. Due to the improvement of dovetailing the resonant frequency and compressibility measurements both as regards time and space, time is saved by taking measurements simultaneously and under identical test conditions, in that, for example, the resonant frequency is measured on a disc brake pad B at the same time as the compressibility is measured on a disc brake pad A.

An advantageous implementation of the invention provides for each measurement on the disc brake pad to be repeated once or several times, wherein with each measurement compressibility and resonant frequency are measured in a time-delayed manner.

A further advantageous implementation of the invention provides for storing the measured values for compressibility and resonant frequency in a data base. The advantage of this is that the measured values may be referred back to at any time for later analyses.

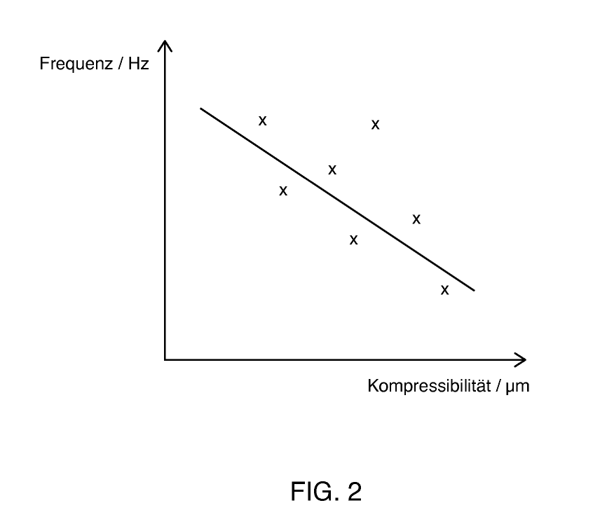

In order to analyse the important connection between resonant frequency and compressibility an important variant of the invention provides for ascertaining the correlation between resonant frequency and compressibility. This involves entering the values of several resonant frequency measurements over the values of several compressibility measurements (see FIG. 2).

The graph of FIG. 2 schematically illustrates the correlation between resonant frequency and compressibility, wherein the measurements are taken on the same disc brake pad, and the values ascertained from these measurements are entered opposite each other. The graph in FIG. 2 is thus based upon six compressibility measurements and six resonant frequency measurements.

This correlation is again characteristic of the elasticity of the pad, thus making it possible to differentiate between different pad elasticity values. The mathematical determination and illustration of the correlation is effected via a corresponding software in a computer unit which again is part of an apparatus for performing the method. The graphic illustration of the correlation between resonant frequency and compressibility thus represents a new analysis method for observing, for example, the robustness of the manufacture of disc brake pads. In addition product developers can gain extended knowledge in a quick and simple way, using the determined correlations, on the basis of an extended data basis. There is thus no need for taking measurements using the expensive ultra-sound method which has been considered in the state of the art.

A further advantageous implementation of the invention provides for the resonant frequencies to be ascertained via microphone measurements, involving two or more microphones. The advantage of using several microphones consists in that the microphones can be used to record the resonant frequency to be measured at different places within the sound field, thereby achieving a more effective avoidance of the nodal lines within the sound field expanding with regard to both time and space. This again leads to greater stability of the measurements as well as a greater measuring and repetition accuracy.

A practical variant of the invention provides for the disc brake pad to be stimulated by a knock. In order to be able to stimulate the disc brake pad using a stimulating force, a pulse-stimulating device may be provided. This pulse-stimulating device may be provided in the form of a hammer.

In order to stop influences of vibrational stimulations originating from the environment, it is convenient if the disc brake pad is decoupled from vibrations in its environment. In order to achieve a coupling between the disc brake pad and the vibrational base (table or similar), it is useful if an object holder for the disc brake pad is provided.

A measuring system for performing the method is the subject of claim 8, wherein the system comprises the following parts:
a measuring device comprising a sensor system, wherein the sensor system comprises microphones;
a data recording apparatus;
a pulse-stimulating device; and
a compressibility-measuring device.

With this arrangement the data recording apparatus is coupled to the compressibility-measuring device and/or the sensor system, wherein the measuring system comprises a computer unit including a data base.

The computer unit may also be part of the data recording apparatus.

Finally the invention provides for a computer program for a computer unit, which program contains an algorithm, which is run as part of the data recording process, whereby the algorithm records the method. The algorithm is additionally run as part of controlling the measuring sequence and/or the evaluation of the measured data.

The invention will now be explained with reference to the drawing, in which:

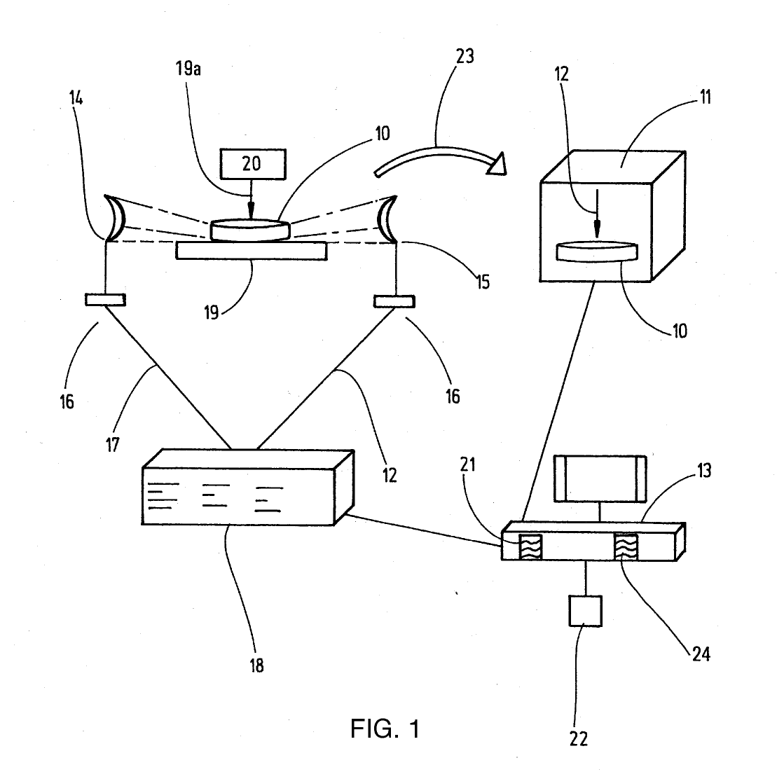

FIG. 1 schematically shows a method according to the invention.

FIG. 2 is a graph schematically illustrating the correlation between resonant frequency and compressibility.

The method 100 according to the invention which is schematically shown in FIG. 1 starts with either measuring the compressibility or with measuring the resonant frequency of the disc brake pad 10.

In the embodiment of the method according to the invention shown in FIG. 1 the resonant frequency of the disc brake pad 10 is initially measured. The resonant frequency measurement is performed in that the microphones 14, 15 of a sensor system 16 are connected via a connection 17 to a data recording apparatus 18 which records the response of the disc brake pad 10 resting on the object holder 19 by means of a measuring computer and a frequency analyser and evaluates it, after the disc brake pad 10 has been stimulated to vibrate by a knock 19a of the pulse-stimulating device 20 indicated by an arrow in FIG. 1. The data recording apparatus 18 is connected to the computer unit 13 which contains a computer program product 21, i.e. a software for measuring the resonant frequency. Measuring the resonant frequency of the disc brake pad 10 is therefore effected by a measuring system which is composed of object holder 19, pulse-stimulating device 20, data recording apparatus 18 and sensor system 16 comprising the two microphones 14, 15.

After the resonant frequency measurement has been carried out, the disc brake pad 10 is fed to the compressibility-measuring device 11, in order to measure the compressibility of the same disc brake pad 10 in a time-delayed manner (symbolised by arrow 23).

To measure the compressibility of disc brake pad 10 the disc brake pad 10 is placed in a compressibility-measuring device 11, in which the change in the thickness of the disc brake pad is measured while applying a one-dimensional compressive load (symbolised by arrow 12) active along the centre line perpendicular to the friction surface of the disc brake pad.

The compressibility-measuring device 11 is also connected to the computer unit 13, which comprises a computer program product 24, i.e. a software for controlling and analysing the compressibility measurement. Thus both the compressibility measurement and the resonant frequency measurement are carried out on the same sample of the disc brake pad 10 in a manner essential to the invention.

It is also possible within the framework of the invention, to employ a sensor system 16 which comprises only one microphone. Alternatively the compressibility measurement can be carried out first. In order to determine the correlation between resonant frequency and compressibility, compressibility and resonant frequency measurements are repeated several times on the same disc brake pad, thereby allowing several measured values on compressibility and resonant frequency to be ascertained. These measured values are stored in a data base 22 which is also part of the computer unit 13. This ensures that, for example, the product developer can refer back at any time to a large data basis containing resonant frequency and compressibility values.

The present invention is not limited to the embodiment described above, which is the preferred embodiment. Rather a number of variants are feasible, which make use of the illustrated solution including for implementations which in principle are quite different. Thus, for example, the number of microphones 14, 15 of the sensor system 16 and the number of measurements carried out can vary a great deal.

1. A method for separately measuring compressibility and resonant frequency of a disc brake pad, characterised in that the compressibility and resonant frequency measurements are carried out on the same disc brake pad in a time-delayed manner, immediately one after the other.

2. The method according to claim 1, characterised in that each measurement is repeated once or several times, wherein for each measurement the compressibility and resonant frequency are measured in a time-delayed manner.

3. The method according to claim 1, characterised in that the values measured for compressibility and resonant frequency are stored in a data base.

4. The method according to claim 3, characterised in that a correlation between compressibility and resonant frequency is ascertained.

5. The method according to claim 1, characterised in that measuring the resonant frequency is carried out by using two or more microphones.

6. The method according to claim 5, characterised in that the disc brake pad is stimulated by a knock.

7. The method according to claim 6, characterised in that the disc brake pad is decoupled from vibrations in its environment.

8. A measuring system for carrying out the method according to any one of claims 1 to 7, comprising:
a measuring device comprising a sensor system, wherein the sensor system comprises microphones, a data recording apparatus, a pulse-stimulating device, and a compressibility-measuring device,
characterised in that
the data recording apparatus is coupled to the compressibility-measuring device or the sensor system and in that the measuring system comprises a computer unit containing a data base.

9. The system according to claim 8, characterised in that the computer unit is part of the data recording apparatus.

10. A computer program for a computer unit for a system according to claim 8, characterised in that the computer unit contains an algorithm, which is run as part of the data recording process, wherein the algorithm records the method according to claim 1.

11. The computer program according to claim 10, characterised in that the algorithm is run as part of controlling a measuring sequence or an evaluation of measured data.
